(19) United States
(12) Patent Application Publication
(10) Pub. No.: US 2002/0031673 A1
(43) Pub. Date: Mar. 14, 2002

(54) TERMINAL CONTACT REINFORCEMENT WITH HIGH TEMPERATURE STABILITY AND METHOD OF PRODUCING SAME

(76) Inventors: HEINZ EISENSCHMID, STUTTGART (DE); THEODOR GRASER, STUTTGART (DE); JOHANN WEHRMANN, STUTTGART (DE)

Correspondence Address: KENYON & KENYON, ONE BROADWAY, NEW YORK, NY, 10004, US

(21) Appl. No.: 09/186,470

(22) Filed: Nov. 5, 1998

(30) Foreign Application Priority Data
Nov. 7, 1997 (DE) 1 97 49 395.5

(51) Int. Cl. B32B 9/04

(52) U.S. Cl. 428/448; 428/623; 204/421; 204/426; 428/209

(57) ABSTRACT

Electric contacting of a sensor element with at least one terminal contact is described; the sensor element is contacted with a contact part by bonding, and this section has a ceramic adhesive on the section connected to the terminal contact. A method of producing the contacting is also described.

### FIELD OF THE INVENTION

The present invention relates to electric contacting of a sensor element and a method of producing the same.

### BACKGROUND INFORMATION

Planar sensor elements for determining the oxygen content in exhaust gases of internal combustion engines require contacting at the surface to pick up the sensor signal and to supply the sensor with a heater voltage. Because of the use of the sensor element in exhaust gas systems of internal combustion engines, the contacts are exposed to temperatures up to approximately 700° C. The contacts must guarantee a reliable electrical and mechanical connection in this high temperature range and must permit simple and safe handling in manufacture.

German Patent Application No. 196 38 208.4 describes electric contacts of a sensor element with at least one terminal contact which is contacted with a contact part by bonding, where at least on the section connected to the terminal contact, the contact part has a layer through which the bonding between the contact part and the terminal contact can be implemented. However, this type of contacting still needs improvement with regard to temperature and vibration stability at the sensor element-contact bridge joint.

In addition, there are known electric contacts of a sensor element with at least one terminal contact, which is contacted with a contact part with material connection, with the contact part having a glass material at least on the section connected to the terminal contact. Terminal contact reinforcement here is achieved by fusing or sintering a glass bead onto it. However, this contacting is complicated to manufacture, resulting in high costs.

### SUMMARY OF THE INVENTION

An object of the present invention is therefore to make available electric contacts of a sensor element to overcome the disadvantages of the related art and make available a contact that is resistant to vibrations, high temperatures and changes in temperature.

The object of the present invention is achieved by electrically contacting a sensor element with at least one terminal contact which is contacted with a contact part by bonding. The contact part has a ceramic adhesive on the section connected to the terminal contact.

This provides an improvement in the aging resistance of the electric contacting. The ceramic adhesive may be in the form of a ceramic casting compound. After hardening on the outside, the adhesive supports the mechanical attachment of the contact part to the terminal contact. In this way, the sensor element is protected from peeling of the contact parts in particular, which can occur due to careless handling in manufacture or due to vibration during operation, for example.

In a preferred embodiment of the present invention, the ceramic adhesive is based on potassium water glass formulations, silica sols or water-soluble aluminates or silicates. Furthermore, it preferably has one or more fillers.

The adhesive is an adhesive compound with a high temperature stability and a temperature of use greater than 800° C. These adhesives are resistant to corrosion and oxidation. Suitable fillers include in particular aluminum oxide (Al₂O₃), magnesium oxide (MgO) and silicon dioxide (SiO₂) because of their good electrical insulation properties. However, zirconium dioxide (ZrO₂) is not suitable because of its ionic conductivity at temperatures above 300° C.

Furthermore, the physical properties such as mechanical strength, thermal expansion, dielectric strength, and thermal and electrical conductivity can be varied and adapted to the sensor element through a suitable choice of fillers.

According to the present invention, in this method of producing the aforementioned contacts, the ceramic adhesive in a pasty form is applied to the section after joining the contact part to the terminal contact, and then it is cured at a temperature between 20° C. and 240° C. A temperature between 70° C. and 240° C. is preferred.

The casting compound is applied to the sensor element after joining the contact parts. To do so, the adhesive compound is metered by a dispenser, for example, and then cured at room temperature. To accelerate the curing process, however, this operation may take place at higher temperatures of 70° C. to 240° C.

A significant advantage of the contacting according to the present invention lies in particular in the improved continuous operating stability under thermal load, thermal shock stress and vibration stress. In addition, no complicated and tedious high temperature processes such as glass melting or sintering are necessary.

### BRIEF DESCRIPTION OF THE DRAWINGS

FIG. 1 shows an oblique top view of a contacted planar oxygen sensor with terminal contact reinforcement according to the present invention.

FIG. 2 shows a contacted planar oxygen sensor without terminal contact reinforcement according to the related art, again in an oblique top view.

### DETAILED DESCRIPTION

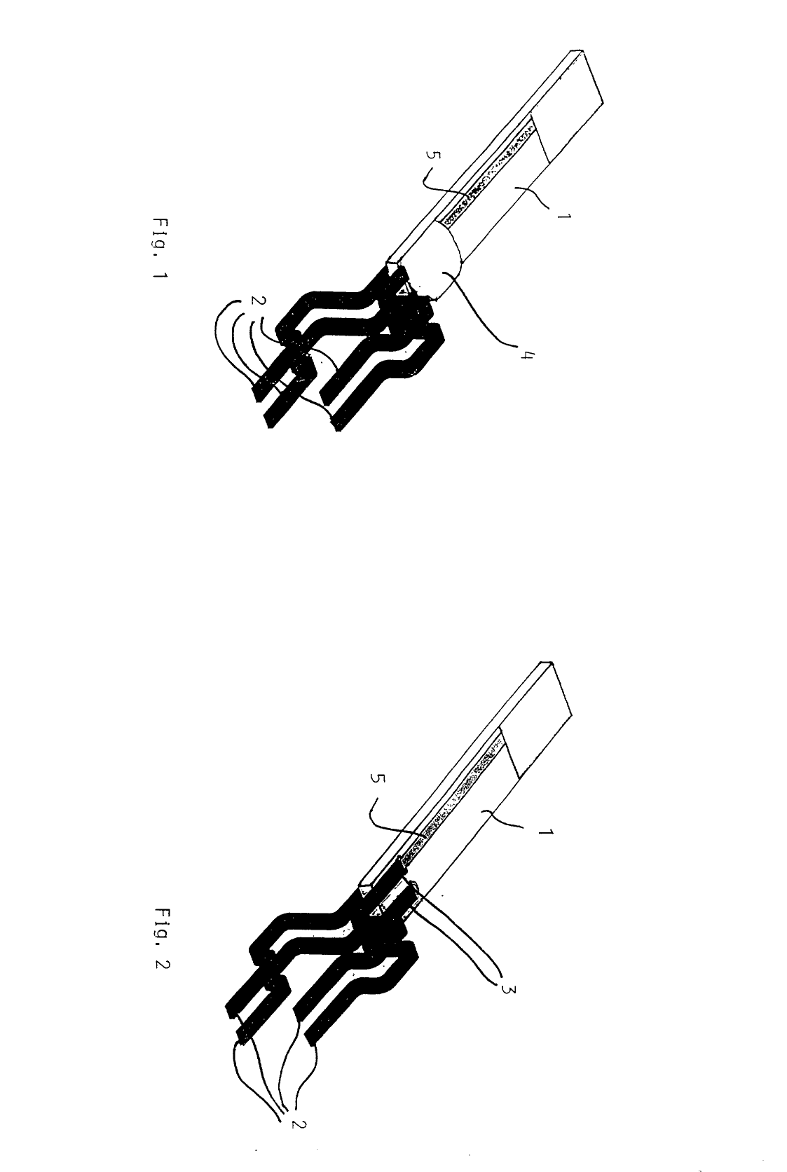

Oxygen sensor 1 is connected to terminal contact 5. In the specific embodiments shown in FIGS. 1 and 2, four contact parts 2 are connected to oxygen sensor 1, with contact part 2 overlapping with terminal contact 5 in terminal contact section 3. According to the present invention, as shown in FIG. 1, ceramic adhesive 4 is situated on this terminal contact section 3.

What is claimed is:

1. An electric contacting arrangement comprising:
a sensor element having at least one terminal contact;
a contact part having a section, the section being bonded to the at least one terminal contact; and
a ceramic adhesive situated on the section of the contact part.

2. The arrangement according to claim 1, wherein the sensor element includes an oxygen sensor.

3. The arrangement according to claim 1, wherein the ceramic adhesive includes at least one of: potassium water glass formulations, silica sols, water-soluble aluminates, and water-soluble silicates.

4. The arrangement according to claim 1, wherein the ceramic adhesive includes at least one filler substance.

5. The arrangement according to claim 1, wherein the ceramic adhesive provides a terminal contact reinforcement.

6. A method of producing a contacting, comprising the steps of:
joining a section of a contact part to a terminal contact of a sensor element;
after the joining step, applying a ceramic adhesive, in a pasty form, to the section of the contact part; and
after the applying step, curing the ceramic adhesive at a temperature between 20° C. and 240° C.

7. The method according to claim 6, wherein the temperature is between 70° C. and 240° C.

8. The method according to claim 6, wherein the ceramic adhesive provides a terminal contact reinforcement.
